(19) United States
(12) Patent Application Publication
(10) Pub. No.: US 2026/0342101 A1
(43) Pub. Date: Oct. 29, 2026

(54) METHODS AND BUTTERFLY APPARATUS FOR TRANSITIONING A RENEWABLE ENERGY POWER PLANT FROM AN ISLANDED CONFIGURATION TO A SUPER-OVERBUILD GRID-CONNECTED CONFIGURATION

(71) Applicant: 1st Avenue Nova, LLC, Los Angeles, CA (US)

(72) Inventor: Thomas BUTTGENBACH, Santa Monica, CA (US)

(21) Appl. No.: 19/656,657

(22) Filed: Apr. 23, 2026

Related U.S. Application Data
(60) Provisional application No. 63/793,462, filed on Apr. 23, 2025.
(60) Provisional application No. 63/878,070, filed on Sep. 8, 2025.

(51) Int. Cl. H02J 3/388; H02J 3/32; H02J 13/12; H02J 101/24

(52) U.S. Cl. CPC H02J 3/388; H02J 3/32; H02J 13/12; H02J 2101/24

(57) ABSTRACT

A system comprises a renewable energy power plant having a power conversion system (PCS) that has fixed characteristics to limit an amount of power and/or current flow, the PCS configured to be electrically coupled to a point of interconnection (POI) of an electrical grid. The renewable energy power plant is configured to be coupled to at least one of a battery energy storage system (BESS) or a behind-the-meter (BTM) load. The renewable energy power plant is configured to (1) send, to the at least one of the BESS or the BTM load, power greater than a power limit of the POI, (2) not send power to the POI that exceeds the power limit of the POI and/or (3) not send current to the POI or draw current from the POI that exceeds the current limit of the POI.

### CROSS REFERENCE TO RELATED APPLICATION

This application claims priority to each of U.S. Provisional Patent Application No. 63/793,462, filed on Apr. 23, 2025 and titled “Methods and Butterfly Apparatus for Transitioning a Renewable Energy Power Plant from an Islanded Configuration to a Super-Overbuild Grid-Connected Configuration,” and U.S. Provisional Patent Application No. 63/878,070, filed on Sep. 8, 2025 and titled “Methods and Butterfly Apparatus for Transitioning a Renewable Energy Power Plant from an Islanded Configuration to a Super-Overbuild Grid-Connected Configuration,” the entirety of each of which is incorporated herein by reference.

### FIELD

The disclosure relates generally to renewable energy power plants that provide power to electrical loads without the power going through an electrical grid, but with the ability to connect to an electrical grid at some time in the future.

### BACKGROUND

Some known power generation systems are capable of delivering electrical power directly to a load without transmission through an electrical grid, while also being capable of selectively connecting to an electrical grid. Similarly, some known renewable energy power generation systems are configured to prevent the delivery of electrical power in excess of a predetermined limit at a point of interconnection with the electrical grid. For example, in one known system for preventing such over-supply of power to the electrical grid, automatic limiting devices are configured to interrupt all power flow to the electrical grid when the power flow exceeds a predefined threshold. In another known system for preventing such over-supply of power to the electrical grid, a programmable control system can restrict the amount of power made available at the point of interconnection. An example of such a programmable control system is disclosed in U.S. Pat. No. 11,831,161, titled “Systems and Methods Utilizing AC Overbuilt Renewable Electric Generation Resource and Charge Storage Device Providing Desired Capacity Factor,” which is incorporated herein by reference.

### SUMMARY

In an embodiment, a system comprises a renewable energy power plant having a power conversion system (PCS) that has fixed characteristics to limit an amount of power or current flow. The PCS is configured to be electrically coupled to a point of interconnection (POI) of an electrical grid. The renewable energy power plant is configured to be coupled to at least one of a battery energy storage system (BESS) or a behind-the-meter (BTM) load. The renewable energy power plant is configured to (1) send, to the at least one of the BESS or the BTM load, power greater than a power limit of the POI, (2) not send power to the POI that exceeds the power limit of the POI and/or (3) not send current to the POI or draw current from the POI that exceeds the current limit of the POI

In some embodiments, a system includes a renewable energy power plant including an electrical bus. The electrical bus is configured to be electrically coupled to a first circuit that includes a battery energy storage system (BESS) and/or a second circuit that includes a behind-the-meter (BTM) load. The renewable energy power plant also includes a power conversion system (PCS). A first portion of the PCS is configured to be electrically coupled to the electrical bus. A second portion of the PCS is configured to be electrically coupled to a third circuit that includes a point of interconnection (POI) of an electrical grid. The PCS is configured to limit at least one of an amount of power or an amount of current flow between the electrical bus and the third circuit. The renewable energy power plant is configured to have a power output higher than a power limit of the POI.

In some embodiments, a system includes a renewable energy power plant having a power conversion system (PCS). The PCS is configured to be electrically coupled to a point of interconnection (POI) of an electrical grid. The renewable energy power plant is configured to be coupled to at least one of a battery energy storage system (BESS) or a behind-the-meter (BTM) load. The renewable energy power plant is configured to send, to the at least one of the BESS or the BTM load, power greater than a power limit of the POI. The PCS is configured to restrict, without communicating with remaining portions of the system, power to the POI that exceeds the power limit of the POI.

In some embodiments, a method includes receiving, during a second time period after a first time period, a signal that indicates an electrical coupling between a renewable energy power plant and a point of interconnection (POI) of an electrical grid. The renewable energy power plant is not electrically coupled to the POI of the electrical grid during the first time period. The method also includes measuring, during the second time period, a voltage and an electric current delivered from an electrical bus associated with the renewable energy power plant to a circuit that includes the POI and through a power conversion system (PCS). The method also includes computing, for the second time period, one of an average product of the voltage and the electric current or an instantaneous product of the voltage and the electric current. The method also includes, limiting a delivery of power from the electrical bus via the PCS to prevent the one of the average product or the instantaneous product from exceeding a predefined power limit associated with the POI.

### BRIEF DESCRIPTION OF THE DRAWINGS

FIG. 1 is a system block diagram showing a renewable energy power plant that can provide its power to a battery energy storage system (BESS), a locally-connected off-grid load (also known as a behind-the-meter (BTM) load) and a point of interconnection (POI) of an electrical grid.

FIG. 2 is a block diagram of a system including renewable resources that can provide power to a BESS, a BTM load and a POI of an electrical grid, in which any power sent to the POI passes through a power-limiting power conversion system, according to embodiment.

FIG. 3 is a block diagram of a system including a renewable energy power plant (or other renewable resources) that can provide its power to a BESS, a BTM load and a POI of an electrical grid, in which any power sent to the POI passes through a power-limiting power conversion system, according to embodiment.

FIG. 4 is a block diagram of a system including a renewable energy power plant (or other renewable resources) in which the common bus uses direct current (DC) power, according to an embodiment.

FIG. 5 is a block diagram of a system including a renewable energy power plant (or other renewable resources) in which the common bus uses alternative current (AC) power, according to an embodiment.

FIG. 6 shows a system block diagram of an inverter circuit, according to an embodiment.

FIG. 7 shows a system block diagram of an AC/AC converter circuit, according to an embodiment.

FIG. 8 shows a flow diagram of a method for limiting power delivered to a POI of an electrical grid, according to an embodiment.

### DETAILED DESCRIPTION

Known industrial facilities that incorporate on-site, local, and dedicated power generation systems are commonly referred to as having “behind-the-meter” (BTM) power plants. A BTM power plant delivers electrical power directly to the industrial facility without transmitting power through the electrical grid or the associated utility meter that measures power received from the grid.

Some known industrial facilities equipped with BTM power plants may operate in one of two configurations. In the first configuration, the facility is grid-connected, allowing it to draw power from the electrical grid to meet its industrial needs during certain periods and deliver power to the grid from its BTM power plant during others. In the second configuration, the industrial facility is not connected to an electrical grid and operates in an “islanded” state, deriving all the power used for its industrial processes from its BTM power plant.

The design characteristics for a BTM power plant can vary depending on whether the industrial facility is grid-connected or islanded. For grid-connected facilities, electricity grid operators typically impose specific limitations on equipment interfacing with the electrical grid to protect the electrical grid from malfunctions originating in the connected hardware and/or control systems. For example, electricity grid operators may require that the total output capacity of all inverters connected to the electrical grid cannot exceed the maximum allowable power deliverable to the electrical grid at the point of interconnection. Alternatively, or in addition, electricity grid operators may require that the total current delivery capacity of all inverters connected to the electrical grid cannot exceed the maximum allowable current deliverable to the electrical grid at the point of interconnection, even in the event of a short circuit at or near the point of interconnection. In contrast, these limitations may not apply to BTM power plants operating in an islanded configuration, resulting in distinct design considerations for such systems.

From an operational perspective, industrial facilities often prefer to maintain a grid connection to provide flexibility. A grid connection allows the facility to draw power from the electrical grid or deliver power to the electrical grid as economically advantageous. Establishing a connection to the electrical grid, however, can involve significant delays due to the electricity grid operator's requirements for impact studies, equipment upgrade determinations, and the scheduling and completion of necessary upgrades, all of which may take several years to complete.

In cases where a grid connection cannot be immediately established, it may be preferable for the industrial facility to operate in an islanded configuration while awaiting grid connection. In such scenarios, it is desirable for the BTM power plant to be initially designed to meet the requirements of an islanded facility and later adapted to function as a grid-connected system. This dual design approach allows for the transition from one configuration to another as operational conditions evolve.

In at least one embodiment described herein, a renewable energy power plant can deliver power to an off-grid load (and any other desired devices such as energy storage systems) at power levels that may be significantly higher than the power that can be delivered to a grid to which the renewable energy power plant is also connected at a point of interconnection. It can be desirable to limit the power that can reach the point of interconnection from the renewable energy power plant.

In other embodiments, a renewable energy power plant can provide power to a battery energy storage system (BESS) and a point of interconnection (POI) to an electrical grid. In such embodiments, the renewable energy power plant does not include a locally-connected off-grid load (also known as a BTM load).

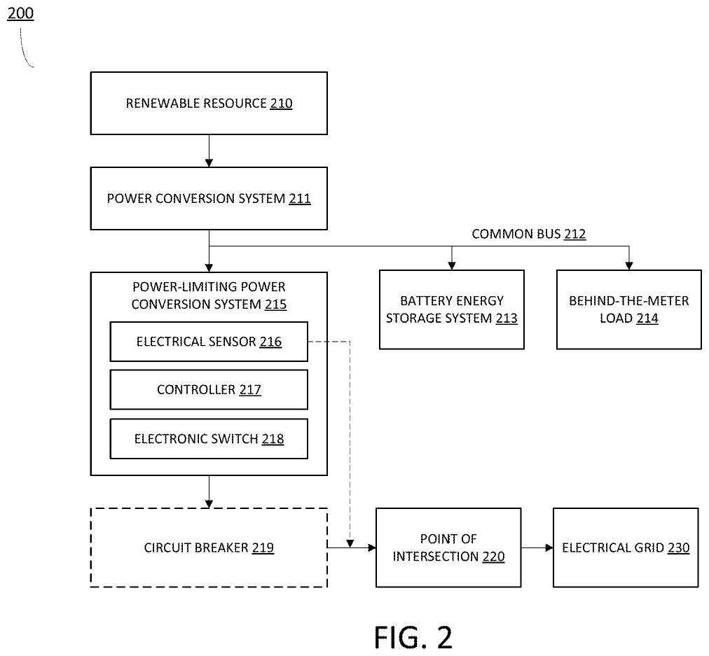

In some embodiments, the renewable energy power plant can be used to deliver power to the electrical grid with a high capacity factor (e.g., more than 50%, more than 60%, and in some instances more than 90% and/or more than 95%). Capacity factor can be, for example, a ratio between the energy delivered during a time period (e.g., in kWh or MWh) and the product of the POI power limit (e.g., in kW or MW) and the duration of the time period (e.g., in hours). In some implementations, the renewable energy power plant can include a large solar array that can generate more power (or have a power output higher) than the POI limit. In some instances, the renewable energy power plant can generate power many times the POI limit, with some of that power going to the POI (during the day) and the rest going to the BESS. Then, in implementations where the BESS is large enough and has enough stored energy, the BESS can discharge all through the night to the electrical grid. Thus, any of the embodiments described herein with a BTM load (such as the embodiments described in connection with FIGS. 2-5) can also apply to a renewable energy power plant with a BESS and not a BTM load.

For example, a renewable energy source may deliver a total energy of 2,400 MWh and have a maximum power output of 400 MW to define a capacity factor of 25% for the renewable energy source. In some instances, that renewable energy source can be connected to an electrical grid with a POI limit of, for example, 100 MW. Thus, the renewable energy source has a maximum power output that is four times the 100 MW POI limit. Of the 400 MW maximum power output, 100 MW could go the electrical grid and the “excess” 300 MW could go to either a BESS and/or a BTM-load. In some instances, the BESS can be large enough (e.g., have a capacity that is large enough) to capture all of the excess energy produced during, for example, peak solar hours, allowing the entire 2,400 MWh to be delivered by the renewable energy power plant and the BESS over a 24-hour period, at a power level of 100 MWh. During that 24-hour period, the renewable energy power plant would always deliver 100 MW to the electrical grid. The capacity factor at the POI of the electrical grid would thus be 100%.

In some embodiments, the renewable energy power plant (e.g., a renewable power supply) can begin in a first configuration as a BTM off-grid power supply for a local industrial load and that can also (or subsequently) be grid-connected in a second configuration. The renewable energy power supply can be sized larger—potentially significantly larger—than the power limit of the grid connection, while also inherently providing protection against overpowering the grid connection even if system controls fail. Alternatively or in addition, the renewable energy power supply can be sized/configured so that a short-circuit current that could otherwise be delivered to the grid POI does not exceed the current limit of the POI even though the renewable energy source can be inherently capable of delivering current that exceeds the current limit of the POI.

In some embodiments, the renewable energy power plant can implement anti-islanding to prevent power delivery into a local distribution system, for example in the event of a grid failure, and to reduce the risk of introducing an electric shock hazard for utility workers.

Some known power distribution solutions include zero export. Zero export can be required by the local utility and does not allow homeowners to deliver power into the grid. A zero export controller often monitors the power flowing through an inverter and to a battery/load, ensuring that the inverter never delivers net power to the electric grid. Stated similarly, typically, a zero export controller can effectively set a zero export power limit for a POI, with a zero or nonzero import power limit for that POI. In contrast to a zero export controller, some embodiments herein can permit the export of nonzero power from a renewable energy power plant to an electrical grid.

Some known power distribution solutions include limited export. Some known export-limiting inverters use current transformers at the POI to monitor power flow. In some instances, the power can be absorbed by a home battery. In some other instances, the solar power can be curtailed (e.g., if the battery is full or already being charged at maximum rate). Solar power is often curtailed by “moving off” (or using a setpoint other than) the MPPT maximum point, within the export-limiting inverter itself. In contrast to some known export-limiting inverters, some embodiments herein can include a power limiting PCS that draws power from a power bus, limiting power therethrough without regard to how the power entered the bus and/or without relying on controlling how the power is redirected or curtailed. In some implementations, portions of the system other than the power limiting PCS can address, for example, how the power enters the bus and/or how to control the power to redirect the power or curtail the power.

In addition, some known export-limiting inverters are in parallel with grid power. Stated similarly, the grid power and a BTM load are often on the same bus, and the solar inverter “hangs on the side” of that same bus. In contrast to such known export-limiting inverters, some embodiments include a power limiting PCS that is in series with grid power. Stated similarly, the grid power flows through the power limiting PCS to go to/from the bus that powers the BTM load.

In addition, standard export limiting is typically a distributed system that uses a meter at an associated POI to communicate with a known export-limiting inverter via, for example, Modbus, SunSpec, and/or PLC. If the communication to/from the known export-limiting inverter is cut (or restricted), the power limiting function of the export-limiting inverter often fails or defaults to a hard shut-off. Unlike such control-class devices, some embodiments herein are and/or include protection-class devices that are each autonomous, communication-independent power limiters.

In addition, some known export-limiting inverters are unidirectional. In contrast, the power limiting PCS's (also referred to herein as Butterfly devices) are, according to some embodiments of the present disclosure, bidirectional, configured to both import power from an electrical grid and/or export power to an electrical grid.

In addition, some embodiments herein include a power limiting PCS that is implemented as an AC/AC converter, in contrast to some known export-limiting inverters that are inherently inverters, inverting DC input to AC output. Furthermore, because the AC/AC converter in some implementations forms the grid-side AC independently, the AC/AC converter can isolate the utility from fault currents on the microgrid side, defining a “grid-hardening” feature of the AC/AC converter.

In addition, some known export-limiting inverters have latency (in some instances due to using a “high level” control loop that involves separate sensor(s), central control software, and communication path(s) and interface(s) between them). The switching inside some power limiting PCS embodiments (e.g., Pulse-Width Modulation) in some implementations enables sub-cycle control, ensuring there is no transient “spike” of power sent to an electrical grid if, for example, a BTM load shuts down suddenly.

Some known utility power distribution solutions include a power plant controller (PPC) that directs a battery energy storage system to increase its charging rate and, in some instances, directs a renewable resource to (partially) curtail, for example in the event when the power coming from the solar exceeds the POI limit. Some known PPC's, however, introduce unacceptable latency (in some instances due to using one or more “high level” control loops that involve separate sensor(s), central control software, and communications path(s) and interface(s) between them). For example, if a 50 MW industrial load suddenly trips offline, a known PPC is often too slow to stop a surge or power from hitting the POI. In contrast to such known PPC's, some embodiments herein include a power limiting PCS with hardware and firmware that implements a low-level controls solution that addresses this limitation. Firmware can be, for example, software of the power-limiting PCS that is tightly integrated with the hardware of the power limiting PCS and that does not change in response to external control signals. In some such implementations, the low-level control loop singularly defines the power limiting function of the power limiting PCS while no other control loops external to the power-limiting PCS affect (or are permitted to affect) the power limiting function of the power limiting PCS.

Some known utility power distribution solutions include a static VAR compensator (SVC). Some known SVC's are massive industrial-scale devices that utilities use to stabilize voltage, through use of power electronics to “absorb” or “inject” reactive power into the grid. Such known SVC's are, therefore, high-power electronic devices positioned at a POI and used to manage grid conditions. However, unlike some embodiments herein, such known SVC's are usually in parallel with an electrical grid (e.g., hung off the side of the bus) rather than in series with an electrical grid (e.g., between the grid and the load bus), and often do not limit real power flow.

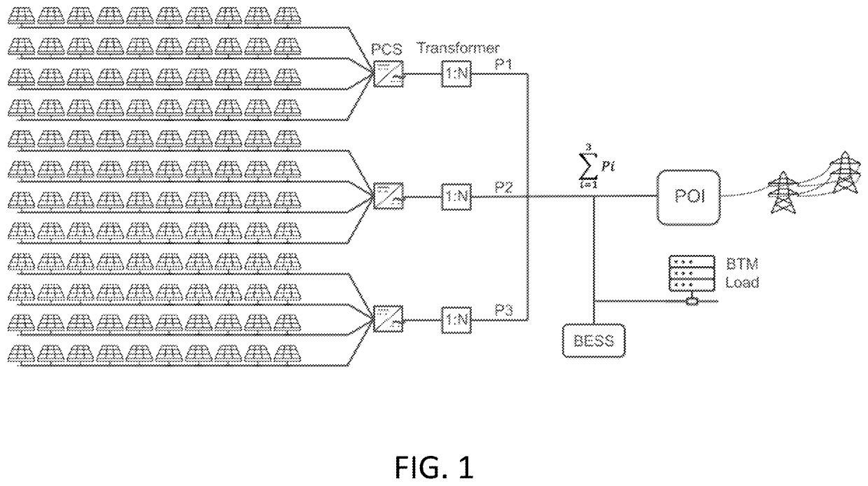

FIG. 1 is a system block diagram showing a renewable energy power plant that can provide its power to a BESS, a locally-connected off-grid load (also known as a BTM load) and a point of interconnection (POI) to an electrical grid. As shown in FIG. 1, solar modules (e.g., multiple solar cells within a common frame) are wired together in series to create so-called “strings.” The power from each string is delivered as direct current (DC) to a Power Conversion System (PCS) (also referred to as a power converter), which can include for example an inverter that converts the current from direct current to alternating current (AC). Each PCS can accept (can be connected to) only a single string, or multiple strings; the example of FIG. 1 shows each PCS as an inverter accepting power from four strings. The AC power output from each PCS can then be delivered to a respective transformer to step up the AC voltage, enabling the power to be transmitted over longer distances with low resistive losses. The power from multiple transformers is readily combined before being transmitted over longer distances.

The maximum combined power is the lesser of (a) the maximum power that can be generated instantaneously by all the solar modules in the array or (b) the sum of the maximum AC power that can be produced by the PCSs (e.g., by the inverter of each PCS). As shown in FIG. 1, the maximum AC power output of inverter #1 is shown as P1; the maximum AC power output of inverter #2 is shown as P2; and the maximum AC power output of inverter #3 is shown as P3. The sum of these three quantities (e.g., summed by a combiner or by a transformer with multiple sets of input windings on one side and a single output winding on the other side) is shown in FIG. 1 as i=1 to 3, ΣPi. This power may be available to deliver power to the behind-the-meter load (labeled in FIG. 1 as “BTM Load”) or to charge the battery energy storage system (BESS), or to deliver power to the grid point of interconnection (POI), or any combination of these.

To protect its grid infrastructure, the electricity grid operator can require that the system cannot deliver more power to the POI than the maximum limit specified for the POI. Specifically, the grid operator can require the power plant operator to limit either or both (a) the maximum total solar generating power and/or (b) the sum of the maximum inverter output powers. The electricity grid operator may allow the maximum power that can be generated by all the solar modules to exceed the POI limit, as long as the sum of the inverter output powers, ΣPi, is less than the POI limit.

This limitation, however, means that the maximum power that can be delivered to the BTM load and the BESS, combined, must also be less than the POI limit. This may be a significant limitation on the design of a renewable energy power plant for a BTM load, as the local grid infrastructure may impose a POI limit that is smaller than the power required by the industrial facility (the BTM load) to be powered. Thus, a need exists for improving the maximum power that can be delivered to the BTM load and/or the BESS, while still satisfying any imposed POI limitations.

FIG. 2 is a block diagram of a system 200 including renewable resources that can provide power to a BESS, a BTM load and a POI to an electrical grid, in which any power sent to the POI passes through a power-limiting power conversion system, according to embodiment. System 200 includes renewable resource 210, PCS 211, common bus 212, BESS 213, BTM load 214, power-limiting PCS 215, optional circuit breaker 219, POI 220, and electrical grid 230. Renewable resource 210 can be electrically coupled to PCS 211. PCS 211 can be electrically coupled, via common bus 212, to each of BESS 213, BTM load 214, and power-limiting PCS 215. Power-limiting PCS 215 can be electrically coupled to optional circuit breaker 219, and, in implementations that do not include optional circuit breaker 219, can be electrically coupled to POI 220. Optional circuit breaker 219 can be electrically coupled to POI 220. POI 220 can be a point of interconnection of electrical grid 230.

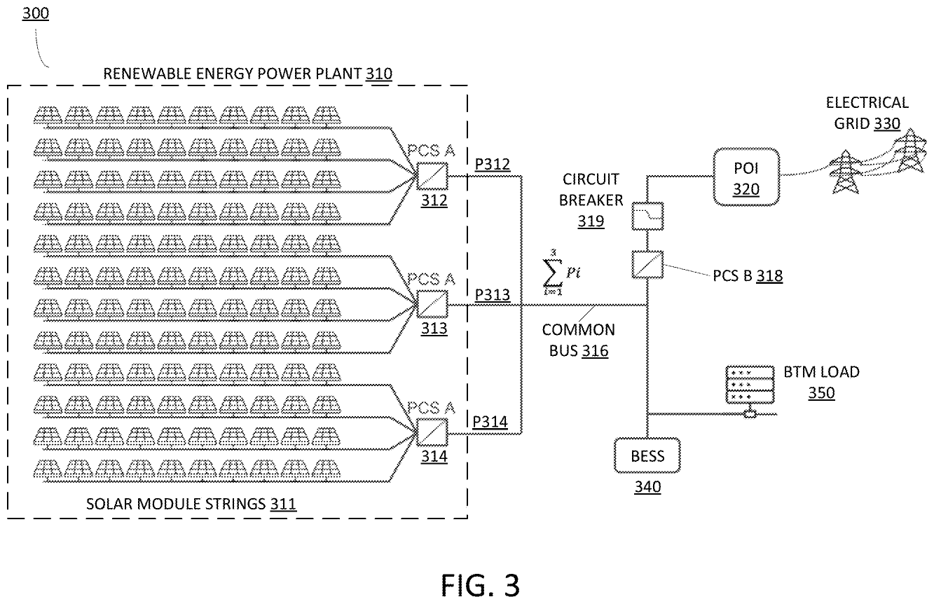

Renewable resource 210 can be configured to generate renewable energy. Renewable resource 210 can be and/or include, for example, a solar cell, a solar panel module, a solar array, a wind turbine, a hydroelectric dam, a geothermal device, a biomass device, and/or the like. In some implementations, renewable resource 210 can be included in a renewable energy power plant that is configured to deliver renewable energy to the electrical grid 230 via point of interconnection 220. Example implementations of renewable resource 210 that incorporate solar-based renewable resources are shown and described in FIGS. 3-5.

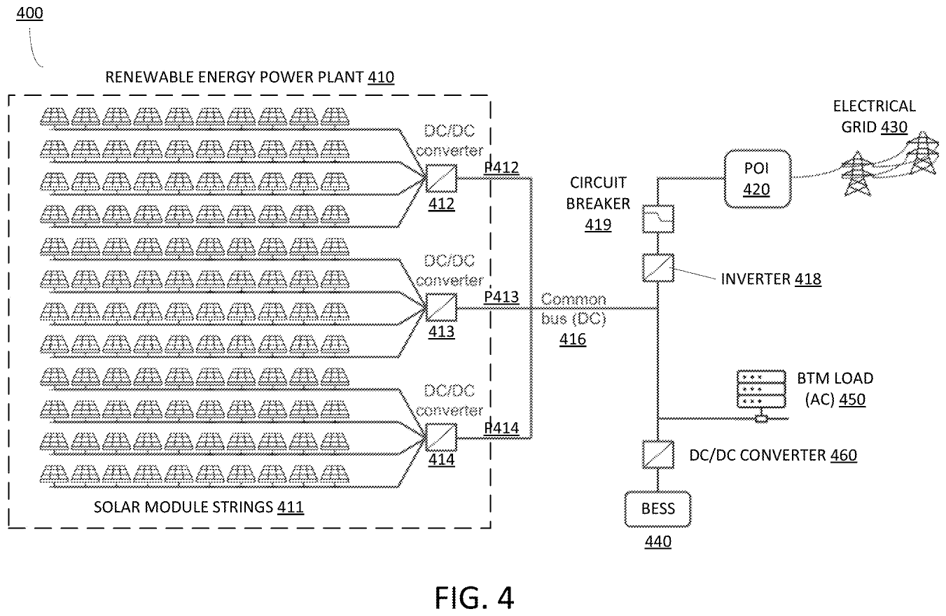

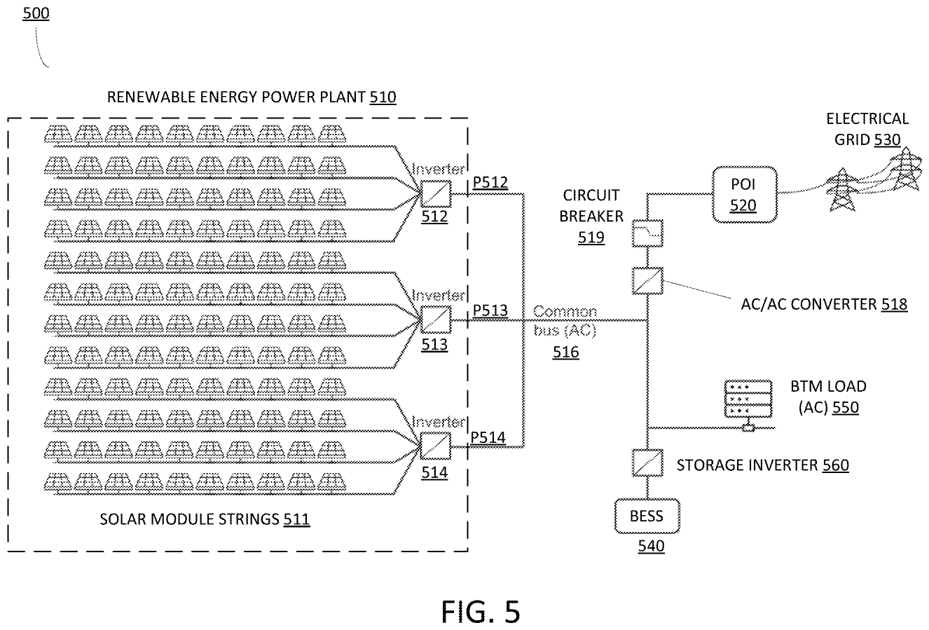

The term PCS is used herein to refer to a component, device or system that converts power from one form to another form. PCS's herein can have varied configurations depending on the situation, but can include or be configured as, for example, an inverter (as shown in FIG. 4 and discussed below), an AC/AC converter (as shown in FIG. 5 and discussed below), a DC/DC converter (e.g., a voltage converter or a more complex device such as an optimizer), or a rectifier (i.e., an AC/DC converter).

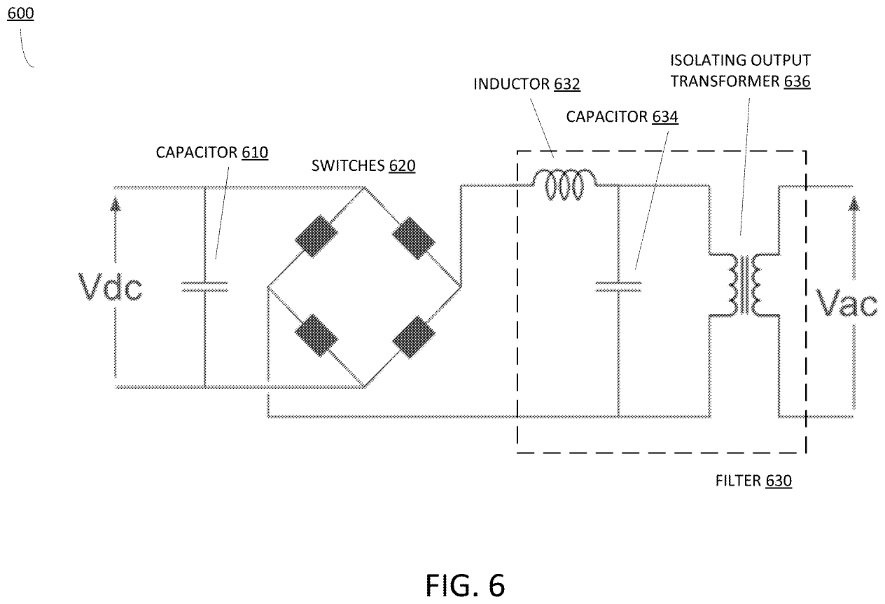

PCS 211 can be configured to convert the renewable energy from renewable resource 210 to a common format (e.g., AC energy, DC energy) associated with common bus 212. In implementations where common bus 212 includes AC power, PCS 211 can be and/or include an embedded transformer, an inverter (e.g., the inverter circuit 600 of FIG. 6, etc.), and/or another type of device that converts DC power to AC power. In implementations where the common bus 212 includes DC power, PCS 211 can be and/or include, for example, a DC/DC converter.

Power-limiting PCS 215 can be a type of PCS (also referred to herein as a “Butterfly PCS”) different from a type of PCS 211. Power-limiting PCS 215 can be configured to accept power in the format used by (or otherwise associated with) the common bus 212, and to convert the format of the bus power to the power format used on the electrical grid 230, which is usually AC and commonly at a high voltage such as 34 kV or more. Power-limiting PCS 215 can include, for example, an embedded transformer on its output to achieve the desired output voltage. Power-limiting PCS 215 is—by design and physics—incapable of delivering more power to the POI 220 or drawing more power from the POI 220 than the corresponding power limit at the POI 220. In some implementations, power-limiting PCS 215 can additionally or alternatively be—by design and physics—incapable of delivering more current to the POI 220, or drawing more current from the POI 220, than the corresponding current limit at the POI 220. The power-limiting PCS 215 can be and/or include a low-level (e.g., hardware and firmware implemented) control loop including an electrical sensor 216, a controller 217, and an electronic switch system 218 that limits, based on the power limit at the POI 220, the power delivered to the POI 220 and, additionally or alternatively, limits, based on the electric current limit of the POI 220, the electric current delivered to (or drawn from) the POI 220.

Electrical sensor 216 can be configured to sense or measure (as indicated by the dashed arrow in FIG. 2) the voltage delivered to the POI 220 and/or the electric current delivered to the POI 220. In some implementations, electrical sensor 216 can measure the voltage and/or the electric current at discrete times, during a time period, during one or more consecutive time periods, and/or during one or more non-consecutive time periods.

Controller 217 can be configured to compute an instantaneous power delivered to the POI 220 and/or an average power delivered to the POI 220, based on the measurements from the electrical sensor 216. For example, controller 217 can be and/or include a PID controller implemented in hardware (e.g., operational amplifiers, resistors, capacitors, inductors, etc.) and firmware, and/or the like. In some implementations, controller 217 can compute the instantaneous product of the two quantities (the voltage delivered to the POI 320 and the electric current delivered to the POI 320) and/or the average of the product of the two quantities over a relevant time period.

Electronic switch system 218 can be and/or include a transistor (e.g., a metal oxide semiconductor field effect transistor (MOSFET), an insulated-gate bipolar transistor (IGBT), etc.), a relay, and/or another suitable device that individually or in combination (e.g., in one or more bridge configuration(s)) is configured to switch, in response to a control signal from controller 217, in a manner that limits the voltage, the electric current, or both. For example, controller 217 as part of the low-level control loop can define and control a duty cycle of electronic switch system 218, to limit either the voltage or the electrical current (or both) at its output. Electronic switch system 218 can limit either the voltage or the electrical current at its output if the instantaneous product thereof (or the average product thereof) exceeds a specified level not greater than the power limit at the POI 220 and/or if the sensed/measured quantity (or, in some cases, an average of the quantity over a relevant time period) exceeds a threshold level not greater than the current limit at the POI 220. The low-level control loop can, in addition, reduce the threshold level in response to sensing, via electrical sensor 216, a reduction in the root-mean-square (or, in the case of DC output, averaged) voltage across the output terminals of the power limiting PCS 215, for example as a safety measure addressing the risk of a downstream short circuit.

In some implementations, power-limiting PCS 215 can be a bidirectional device (or can otherwise have bidirectional capability), capable of converting a power format of bus power from the common bus 212 to a power format of grid power on the electrical grid 230, or converting a power format of grid power from the electrical grid 230 to a power format of bus power on the common bus 212. For example, power-limiting PCS 215 can be configured as a bidirectional device when power-limiting PCS 215 includes dual-active-bridge (DAB) circuit architectures.

In some implementations, power-limiting PCS 215 can include internal controls (including at least controller 217). The internal controls can be implemented, for example in hardware and firmware (e.g., as an integrated circuit such as an application specific integrated circuit (ASIC), a field programmable gate array (FPGA), a programmable logic array (PLA), etc.), and configured to control operation of an associated PCS without coordination with any other devices such as any other devices within the system 200. In other words, a single power-limiting PCS 215 can perform associated (or predefined, preselected) control functions independent of any other device from system 200, for example to ensure that the POI is protected. Said another way, the power-limiting PCS 215 can limit the power (and/or electric current) flow therein without coordination with other devices such as the remaining PCS devices of system 200 and/or remaining components of system 200. In other words, the PCSs of system 200 such as power-limiting PCS 215 can include hardware and optionally software (e.g., firmware) that are part of or are internal to those PCS devices. The protection function provided by the PCSs of system 200 does not depend on the measurement of electrical parameters in other parts of the system 200 nor on short-time (e.g., abrupt, transient) control inputs from devices outside of the PCSs.

Optional circuit breaker 219, in response to sensing that the electric current flowing to the POI 220 and/or the electric current flowing from the POI 220 exceeds a pre-set or predefined threshold, can be configured to entirely disconnect the electric current path to the POI 220. In some implementations the circuit breaker 219 can be included, for example, as an additional means to protect the POI 220. A circuit breaker 219 trigger event completely stops or restricts the flow of power to the electrical grid 230, rather than merely limiting it. Thus, circuit breaker 219 trigger events can be infrequent and used sparingly.

In use, renewable resource 210 can have a power output (e.g., an instantaneous power output measured in megawatts or kilowatts) higher than a power limit of POI 220. Because the power-limiting PCS 215 prevents excessive power flow to the POI 220, system 200 can improve the maximum power that can be delivered to the BTM load 214 and/or the BESS 213, while still satisfying any imposed POI 220 limitations. For example, a renewable energy power plant that includes renewable resource 210 and PCS 211 and that is electrically coupled to BESS 213, BTM load 214, and power-limiting PCS 215 via common bus 212, can (1) send, to the BTM load 214 and/or the BESS 213 power greater than a power limit of the POI 220 and (2) not send power to the POI 220 that exceeds the power limit of the POI 220. More specifically, such a renewable energy power plant can send, to the BTM load 214 and/or the BESS 213, power that is multiple times greater than the power limit of the POI 220 (e.g., two times, three times, four times, five times, six times, seven times, eight times, nine times, and even greater times). Recognizing that a multiple greater than one time, with power sent to the POI 220 being controlled by a software-controlled energy management system, is referred to herein as an “Overbuild,” a multiple greater than two times and/or with hardware control of the power sent to the POI 220 is referred to herein as a “Super-overbuild.”

One or more embodiments described herein including, for example, the embodiment of system 200 shown in FIG. 2, can protect a POI disposed between a renewable energy power plant and an electrical grid in ways that differ from known systems. For example, U.S. Pat. No. 11,831,161 describes a known control system that can manage the power flow to a BESS and the power flow from a BESS, the power flow to a BTM load and the power flow from a BTM load, and power flow from a renewable generation device, so that the net power available to a POI does not exceed a POI limit. In sharp contrast, one or more embodiments described herein do not rely on controls of that type; instead, the power limiting PCS implementations herein such as power-limiting PCS 215 of FIG. 2, PCS B 318 of FIG. 3, inverter 418 of FIG. 4, and AC/AC converter 518 of FIG. 5 each physically limits the amount of power and/or electric current that can flow to an associated POI including, respectively, the POI 220 of FIG. 2, the POI 320 of FIG. 3, the POI 420 of FIG. 4, and the POI 520 of FIG. 5. In other words, the power limiting PCS implementations herein can physically limit the amount of power and/or electric current that can flow to an associated POI based on, for example, the hardware configuration of the power limiting PCS having predefined, preselected and/or fixed characteristics or operational values. Such a hardware configuration of the power limiting PCS implementations herein does not include (or require) external software-based/external programmable control and does not include (or use) an external power meter(s) that in some implementations can monitor the power flows within an associated renewable energy power plant. In other words, the power limiting PCS implementations herein can include hardware and optionally software (e.g., firmware) that are part of or are internal to that power limiting PCS implementation. In other words, the power limiting PCS implementations herein may not be communicatively coupled to remaining components of a system that includes the power limiting PCS. The protection function provided by the power limiting PCS implementations herein do not depend on the measurement of electrical parameters in other parts of an associated renewable energy power plant nor on short-time control inputs from devices outside of that power limiting PCS implementation. Similarly, the hardware configuration of the power limiting PCS implementations herein need not use forecast information such as a renewable generation forecast (e.g., a solar generation forecast).

In some embodiments, a system can include multiple POIs between a renewable resource (or a renewable energy power plant) and an electrical grid. In some implementations, such a system can include a different power-limiting PCS for each POI. In some implementations, a power limitation (or a maximum acceptable power) and/or electric current limitation (or a maximum acceptable electric current) can be assigned to each PCS from the multiple PCSs based on the power limit and/or electric current limit of an associated POI from the multiple POIs. In some implementations, each POI from the multiple POIs can be a POI of a different electrical grid or other type of electric infrastructure.

FIG. 3 is a block diagram of a system 300 including a renewable energy power plant (or other renewable resources) that can provide its power to a BESS, a BTM load and a POI to an electrical grid, in which any power sent to the POI passes through a power-limiting power conversion system, according to embodiment. System 300 includes renewable energy power plant 310, common bus 316, PCS B 318 (e.g., structurally and/or functionally similar to power limiting PCS 215 of FIG. 2), optional circuit breaker 319 (e.g., structurally and/or functionally similar to optional circuit breaker 219 of FIG. 2), POI 320 (e.g., structurally and/or functionally similar to POI 220 of FIG. 2), electrical grid 330 (e.g., structurally and/or functionally similar to electrical grid 230 of FIG. 2), BESS 340 (e.g., structurally and/or functionally similar to BESS 213 of FIG. 2), and BTM load 350 (e.g., structurally and/or functionally similar to BTM load 214 of FIG. 2). Renewable energy power plant 310 can be electrically coupled to common bus 316. Common bus 316 can be electrically coupled to PCS B 318, which (alone or in combination with optional circuit breaker 319) serves as a “bridge” between common bus 316 and POI 320. POI 320 can be electrically coupled to (or integrated with) electrical grid 330. Common bus 316 can be electrically coupled to each of BESS 340 and BTM load 350.

Renewable energy power plant 310 includes solar module strings 311, PCS A 312, PCS A 313, and PCS A 314. Solar module strings 311 includes, by way of example, twelve solar module strings that define three groups (or sets) of four solar module strings each, where each solar module string of a common group is electrically coupled to remaining solar module strings of the common group in a parallel configuration and with respect to a common node. As shown, a first group of solar module strings from the solar module strings 311 is electrically coupled to an input portion of PCS A 312, a second group of solar module strings from the solar module strings 311 is electrically coupled to an input portion of PCS A 313, and a third group of solar module strings from the solar module strings 311 is electrically coupled to an input portion of PCS A 314. Accordingly, each group of solar module strings 311 can be electrically coupled to a different PCS from PCS A 312, PCS A 313, and PCS A 314. An output portion of each of PCS A 312, PCS A 313, and PCS A 314 can be electrically coupled to common bus 316 by, for example, a combiner, a transformer, or another suitable circuit. Common bus 316 can be electrically coupled to a first feeder (or circuit) that includes PCS B 318 and electrically coupled to a second feeder (or circuit) that includes each of BESS 340 and BTM load 350, where the first feeder and the second feeder define a parallel configuration for electric current flow, based on the common bus 316. PCS B 318 can be electrically coupled to circuit breaker 319, which is electrically coupled to POI 320.

Each solar module string from solar module strings 311 can include one or more solar modules that are electrically coupled together in a series configuration and that each generate electrical power based on a conversion of solar energy to electrical energy. Solar module strings 311 can provide power to each of PCS A 312, PCS A 313, and PCS A 314.

Each of PCS A 312, PCS A 313, and PCS A 314 can be configured to convert the solar module power of the respective group from solar module strings 311 to a common format—which can be DC or AC—to define respective power outputs P312, P313, and P314. Power outputs P312, P313, and P314 can be merged or combined as a sum (e.g., by a combiner or by a transformer with multiple sets of input windings on one side and a single output winding on the other side) onto a common bus 316 to define a bus power. In implementations where the common bus 316 uses AC power, each of PCS A 312, PCS A 313, and PCS A 314 can include, for example, an embedded transformer, an inverter (e.g., the inverter circuit 600 of FIG. 6, etc.), and/or the like. In implementations where the common bus 316 uses DC power, each of PCS A 312, PCS A 313, and PCS A 314 can include, for example, a DC/DC converter.

The common bus 316 can be composed of (comprise, include) any number of conductors, and the total bus power on the common bus can be allocated among the conductors. For example, the common bus 316 can be a DC bus with six conductors in pairs, each pair carrying one third of the total bus power on the common bus. Following this example, three instances of PCS B 318 can distribute bus power, respectively, to three instances of POI 320, with power limitations on each PCS B 318 instance being based on the power capacity of the respective, associated POI 320 instance. Alternatively, a single PCS B 318 can combine power from all six conductors (in this example), so that only a single POI 320 and a single power limit is applied to (or otherwise associated with) the single PCS B 318.

The PCS B 318 can be configured to accept power in the format used by (or otherwise associated with) the common bus 316, and to convert the format of the bus power to the power format used on the electrical grid 330—usually AC and commonly at a high voltage such as 34 kV or more. The PCS B 318 can include, for example, an embedded transformer on its output to achieve the desired output voltage. PCS B 318 can be configured to limit power delivered to POI 320 based on a power limit of the POI 320. PCS B 318 can alternatively or additionally be configured to limit the electrical current delivered to (or drawn from) POI 320 based on a current limit of the POI 320. For example, PCS B 318 can include an electrical sensor (e.g., electrical sensor 216 of FIG. 2; not shown in FIG. 3), a controller (e.g., controller 217 of FIG. 2; not shown in FIG. 3), and an electronic switch (e.g., electronic switch system 218 of FIG. 2; not shown in FIG. 3) that define a low level control loop with a setpoint (e.g., a value no greater than a power limit of POI 320 and/or a current limit of POI 320).

In some implementations, PCS B 318 can be a bidirectional device (or can otherwise have bidirectional capability), capable of converting a power format of bus power from the common bus 316 to a power format of grid power on the electrical grid 330, or converting a power format of grid power from the electrical grid 330 to a power format of bus power on the common bus 316. For example, PCS B 318 can be configured as a bidirectional device when PCS B 318 includes dual-active-bridge (DAB) circuit architectures.

In some implementations, the PCS B 318 can each include internal controls (not shown) implemented, for example in hardware and firmware (e.g., as an integrated circuit such as an application specific integrated circuit (ASIC), a field programmable gate array (FPGA), a programmable logic array (PLA), etc.) and configured to control a power limiting operation without coordination with any other devices such as any other devices within the renewable energy power plant 310 or the system 300. In other words, a single PCS (e.g., PCS A 312, PCS A 313, PCS A 314, and/or PCS B 318) can perform associated (or predefined, preselected) control functions independent of any other device from system 300. Said another way, the PCS B 318 can limit the power (and/or electric current) flow therein without coordination with other devices such as the remaining PCS devices of system 300 and/or remaining components of system 200. In other words, the PCSs of system 300 such as PCS B 318 can include hardware and optionally software (e.g., firmware) that are part of or are internal to those PCS devices. The protection function provided by the PCSs of system 300 does not depend on the measurement of electrical parameters in other parts of the renewable energy power plant 310 nor on short-time (e.g., abrupt, transient) control inputs from devices outside of the PCSs.

In use, renewable energy power plant 310 can have a power output (e.g., an instantaneous power output measured for example in megawatts or kilowatts) higher than a power limit of POI 320. Because the power-limiting PCS B 318 prevents excessive power flow to the POI 320, system 300 can improve the maximum power that can be delivered to the BTM load 350 and/or the BESS 340, while still satisfying any imposed POI 320 limitations. For example, the renewable energy power plant 310 can (1) send, to the BTM load 350 and/or the BESS 340 power greater than a power limit of the POI 320 and (2) not send power to the POI 320 that exceeds the power limit of the POI 320. More specifically, the renewable energy power plant 310 can send, to the BTM load 350 and/or the BESS 340, power that is multiple times greater than the power limit of the POI 320 (e.g., two times, three times, four times, five times, six times, seven times, eight times, nine times, and even greater times).

In some embodiments, a system can include multiple POIs between a renewable energy power plant and an electrical grid. In some implementations, such a system can include a different PCS (e.g., structurally and/or functionally similar to PCS B 318) for each POI. In some implementations, a power limitation (or a maximum acceptable power) and/or electric current limitation (or a maximum acceptable electric current) can be assigned to each PCS from the multiple PCSs based on the power limit and/or electric current limit of an associated POI from the multiple POIs. In some implementations, each POI from the multiple POIs can be a POI of a different electrical grid or other type of electric infrastructure.

Although system 300 is shown as including twelve solar module strings that define three groups (or sets) of four solar module strings, and three PCS A's, in some embodiments, a system can have a different number of solar module strings and/or a different number of PCS A's. For example, a system can have one solar module string and one PCS A, two solar module strings and one PCS A, two solar module strings and two PCS A's, three solar module strings and one PCS A, three solar module strings and two PCS A's, three solar module strings and three PCS A's, and so on. In some embodiments, the solar module strings 311 of system 300 can alternatively be replaced with (or can additionally be supplemented with) a renewable energy source different from a solar-based energy source such as wind turbines, hydroelectric dams, geothermal devices, etc.

FIG. 4 is a block diagram of a system 400 including a renewable energy power plant (or other renewable resources) in which a common bus uses DC power, according to an embodiment. System 400 includes renewable energy power plant 410, common bus 416, inverter 418, optional circuit breaker 419 (e.g., structurally and/or functionally similar to optional circuit breaker 219 of FIG. 2), POI 420 (e.g., structurally and/or functionally similar to POI 320 of FIG. 3), electrical grid 430 (e.g., structurally and/or functionally similar to electrical grid 330 of FIG. 3), BESS 440 (e.g., structurally and/or functionally similar to BESS 340 of FIG. 3), BTM load 450 (e.g., structurally and/or functionally similar to BTM load 350 of FIG. 3), and DC/DC converter 460. Renewable energy power plant 410 can be electrically coupled to common bus 416. Common bus 416 can be electrically coupled to inverter 418, which (alone or in combination with optional circuit breaker 419) serves as a “bridge” between common bus 416 and POI 420. POI 420 can be electrically coupled to (or integrated with) electrical grid 430. Common bus 416 can be electrically coupled to each of BESS 440 and BTM load 450.

Renewable energy power plant 410 can be an implementation of renewable energy power plant 310 when common bus 316 is a DC bus. Renewable energy power plant 410 includes solar module strings 411, DC/DC converter 412, DC/DC converter 413, and DC/DC converter 414. Solar module strings 411 includes, by way of example, twelve solar module strings that define three groups (or sets) of four solar module strings, where each solar module string of a common group is electrically coupled to remaining solar module strings of the common group in a parallel configuration and with respect to a common node. As shown, a node of a first group of solar module strings 411 is provided to an input portion of DC/DC converter 412, a node of a second group of solar module strings 411 is provided to an input portion of DC/DC converter 413, and a node of a third group of solar module strings 411 is provided to an input portion of DC/DC converter 414. Accordingly, each group of solar module strings 411 can be electrically coupled to a different DC/DC converter from DC/DC converter 412, DC/DC converter 413, and DC/DC converter 414. An output portion of each of DC/DC converter 412, DC/DC converter 413, and DC/DC converter 414 can be electrically coupled to DC common bus 416 by, for example, a combiner, a transformer, or another suitable circuit (not shown in FIG. 4). DC common bus 416 can be electrically coupled to a first feeder (or circuit) that includes inverter 418. DC common bus 416 can be electrically coupled to a second feeder (or circuit) that includes DC/DC converter 460. DC common bus 416 can be electrically coupled to a third feeder (or circuit) that includes BTM load 450, where the first feeder, the second feeder, and the third feeder define a parallel configuration for electric current flow based on the DC common bus 416. Inverter 418 can be electrically coupled to circuit breaker 419, which is electrically coupled to POI 420.

Solar module strings 411 can be structurally and/or functionally similar to solar module strings 311 of FIG. 3. Solar module power from the renewable generation by solar module strings 411 can be supplied to each of DC/DC converter 412, DC/DC converter 413, and DC/DC converter 414.

In some implementations, DC/DC converter 412 can be structurally and/or functionally similar to PCS A 312, DC/DC converter 413 can be structurally and/or functionally similar to PCS A 313, and DC/DC converter 414 can be structurally and/or functionally similar to PCS A 314, when common bus 316 is a DC bus. In some implementations, DC/DC converter 412, DC/DC converter 413, and/or DC/DC converter 414 can each have maximum power point tracking (MPPT) inputs (not shown). The MPPT input can be configured to adjust the associated solar module strings 311 voltage to a voltage that causes delivery of a maximum amount of power to the associated DC/DC converter, which then combines and delivers an output voltage at a defined DC common bus 416 voltage. The outputs P412, P413, and P414 of DC/DC converter 412, DC/DC converter 413, and DC/DC converter 414, respectively, can be combined, for example, by a combiner or a transformer with multiple sets of input windings on one side and a single output winding on the other side. The DC/DC converter 412 with an MTTP input, the DC/DC converter 413 with an MTTP input, and the DC/DC converter 414 with an MTTP input can each include a feature to curtail generation, by adjusting the solar module strings 411 voltage to a value that reduces power below its maximum value.

Inverter 418 can be structurally and/or functionally similar to PCS B 318 when common bus 316 is a DC bus. Inverter 418 can be an inverter-type PCS with an output power less than or equal to the power limit at the POI 420. Inverter 418 can be configured to receive power from the DC common bus 416 and convert the bus power to AC power for the electrical grid 430. For example, the inverter 418 can incorporate (or include) a transformer to adjust the output voltage appropriately based on the specifications of the electrical grid 430. Inverter 418 can be configured to limit the electric current to be delivered to or to be drawn from the POI 420. For example, inverter 418 can limit the electric current to a specified value, based on predefined or preselected characteristics of inverter 418.

In some implementations, inverter 418 can include internal controls (not shown) implemented in hardware (and in some instances firmware) and configured to control operation of inverter 418 without coordination with any other devices such as any other devices within the renewable energy power plant 410 or the system 400. In other words, the inverter 418 can perform associated (or predefined, preselected) control functions independent of any other device from system 400. Said, another way, the inverter 418 can limit the power and/or electric current flow therein without coordination with other devices such as other devices within the renewable energy power plant 410 or the system 400.

DC/DC converter 460 is shown connecting the DC common bus 416 to the battery energy storage system (BESS) 440. The desired input/output voltage range for the BESS 440 may differ from the voltage on the DC common bus 416, and so the DC/DC converter 460 can be configured to change the voltage on the DC common bus 416 to the desired input/output voltage range for the BESS 440.

In use, renewable energy power plant 410 can have a power output higher than and in some instances many times that of a power limit of POI 420. An advantage of embodiments with a DC common bus such as system 400 is that a grid frequency need not be set on the DC common bus such as DC common bus 416.

Although system 400 is shown as including twelve solar module strings that define three groups (or sets) of four solar module strings, and three PCS A's implemented as DC/DC converters, in some embodiments, a system can have a different number of solar module strings and/or a different number of PCS A's implemented as DC/DC converters. In some embodiments, the solar module strings 411 of system 400 can alternatively be replaced with (or can additionally be supplemented with) a renewable energy source different from a solar-based energy source such as wind turbines, hydroelectric dams, geothermal devices, etc. Although system 400 is shown as including one POI 420 between renewable energy power plant 410 and electrical grid 430, in some embodiments, a system can include multiple POIs, as described herein.

FIG. 5 is a block diagram of a system 500 including a renewable energy power plant (or other renewable resources) in which the common bus uses AC power, according to an embodiment. System 500 includes renewable energy power plant 510, common bus 516, AC/AC converter 518, optional circuit breaker 519 (e.g., structurally and/or functionally similar to optional circuit breaker 219 of FIG. 2), POI 520 (e.g., structurally and/or functionally similar to POI 320 of FIG. 3), electrical grid 530 (e.g., structurally and/or functionally similar to electrical grid 330 of FIG. 3), BESS 540 (e.g., structurally and/or functionally similar to BESS 340 of FIG. 3), BTM load 550 (e.g., structurally and/or functionally similar to BTM load 350 of FIG. 3), and storage inverter 560. Renewable energy power plant 510 can be electrically coupled to common bus 516. Common bus 516 can be electrically coupled to AC/AC converter 518, which (alone or in combination with optional circuit breaker 519) serves as a “bridge” between common bus 516 and POI 520. POI 520 can be electrically coupled to (or integrated with) electrical grid 530. Common bus 516 can be electrically coupled to BESS 540 via storage inverter 560, and to BTM load 550.

Renewable energy power plant 510 can be structurally and/or functionally similar to renewable energy power plant 310 when common bus 316 is an AC bus. Renewable energy power plant 510 includes solar module strings 511, inverter 512, inverter 513, and inverter 514. Solar module strings 511 includes, by way of example, twelve solar module strings that define three groups (or sets) of four solar module strings, where each solar module string of a common group is electrically coupled to remaining solar module strings of the common group in a parallel configuration and with respect to a common node. As shown, a node of a first group of solar module strings 511 is provided to an input portion of inverter 512, a node of a second group of solar module strings 511 is provided to an input portion of inverter 513, and a node of a third group of solar module strings 511 is provided to an input portion of inverter 514. Accordingly, each group of solar module strings 511 can be electrically coupled to a different PCS from inverter 512, inverter 513, and inverter 514. An output portion of each of inverter 512, inverter 513, and inverter 514 can be electrically coupled to AC common bus 516 by, for example, a combiner, a transformer, or another suitable circuit. AC common bus 516 can be electrically coupled to a first feeder (or circuit) that includes AC/AC converter 518. AC common bus 516 can be electrically coupled to a second feeder (or circuit) that includes storage inverter 560. AC common bus 516 can be electrically coupled to a third feeder (or circuit) that includes BTM load 550, where the first feeder, the second feeder, and the third feeder define a parallel configuration for electric current flow based on AC common bus 516. AC/AC converter 518 can be electrically coupled to circuit breaker 519, which is electrically coupled to POI 520.

Solar module strings 511 can be structurally and/or functionally similar to solar module strings 311 of FIG. 3. Solar module power from the renewable generation by solar module strings 511 can be supplied to each of inverter 512, inverter 513, and inverter 514.

Inverter 512 can be structurally and/or functionally similar to PCS A 312, inverter 513 can be structurally and/or functionally similar to PCS A 313, and inverter 514 can be structurally and/or functionally similar to PCS A 314, when common bus 316 is an AC bus. Each of inverter 512, inverter 513, and inverter 514 can be configured to convert the respective DC power from the renewable generation by associated solar module strings 511 to AC power for the AC common bus 516. For example, the inverter 512, inverter 513, and inverter 514 can each incorporate (or include) transformers, to increase the voltage on the AC common bus 516 to an appropriate output voltage. The outputs P512, P513, and P514 of inverter 512, inverter 513, and inverter 514, respectively, can be combined, for example, by a combiner or a transformer with multiple sets of input windings on one side and a single output winding on the other side.

AC/AC converter 518 can be an implementation of PCS B 318 when common bus 316 is an AC bus. AC/AC converter 518 can be a converter-type PCS with an output power less than or equal to the power limit at the POI 520. AC/AC converter 518 can be configured to receive power from the AC common bus 516 and convert the bus power to AC power for the electrical grid 530, while limiting the amount of power and/or electric current that can be transmitted to the POI 520 and/or the amount of power and/or electric current that can be transmitted from the POI 520.

In some implementations, AC/AC converter 518 can include internal controls (not shown) implemented in hardware (and in some instances firmware) and configured to control operation of AC/AC converter 518 without coordination with any other devices such as any other devices within the renewable energy power plant 510 or the system 500. In other words, the AC/AC converter 518 can perform associated (or predefined, preselected) control functions independent of any other device from system 500. Said, another way, the AC/AC converter 518 can limit the power and/or electric current flow therein without coordination with other devices such as other devices within the renewable energy power plant 510 or the system 500.

The AC common bus 516 can operate at a different voltage and, in some instances, at a different frequency from the voltage and/or frequency of the electrical grid 530. Accordingly, the AC/AC converter 518 can be configured to convert the AC common bus 516 AC power to electrical grid 530 AC power. For example, the AC/AC converter 518 can incorporate (or include) a transformer to adjust the output voltage appropriately. The AC/AC converter 518 can effectively isolate the AC common bus 516 from the electrical grid 530. Consequently, the inverters driving the AC common bus 516 including inverter 512, inverter 513 and inverter 514 in some instances do not have access to the grid frequency or the grid voltage. As a result, it can be desirable for devices within the renewable energy power plant 510 to set the frequency and the voltage on the AC common bus 516. For example, each of inverter 512, inverter 513, and inverter 514 can in some implementations be grid-forming inverters.

Storage inverter 560 connects the AC common bus 516 to the battery energy storage system (BESS) 540. To charge the BESS 540, storage inverter 560 can be configured to rectify an AC output from the AC common bus 516 to a DC input suitable for BESS 540. For example, storage inverter 560 can include an AC-DC converter (or other rectifier circuit; not shown) configured to rectify AC power from the AC common bus 416 to produce a DC output that matches the voltage specifications of the BESS 540. Instead, or in addition, the AC-DC converter of the storage inverter 560 can produce an intermediate DC output, and a DC-DC converter (not shown) can convert the intermediate DC output to a DC output that matches the voltage specifications of the BESS 540. To discharge the BESS 540, storage inverter 560 can be configured to invert a DC output from the BESS 540 to an AC output suitable for the AC common bus 516. For example, storage inverter 560 can include a DC-AC converter (or other inverter circuit; not shown) configured to invert DC power from the BESS 540 to produce an AC output that matches the voltage specifications of the AC common bus 516. Instead, or in addition, the DC-AC converter of the storage inverter 560 can produce an intermediate AC output, and an AC-AC converter (not shown) can convert the intermediate AC output to an AC output that matches the voltage specifications of the AC common bus 516.

In use, renewable energy power plant 510 can have a power output higher than and in some instances many times that of a power limit of POI 520.

Although system 500 is shown as including twelve solar module strings that define three groups (or sets) of four solar module strings, and three PCS A's implemented as inverters, in some embodiments, a system can have a different number of solar module strings and/or a different number of PCS A's implemented as inverters. In some embodiments, the solar module strings 511 of system 500 can alternatively be replaced with (or can additionally be supplemented with) a renewable energy source different from a solar-based energy source such as wind turbines, hydroelectric dams, geothermal devices, etc. Although system 500 is shown as including one POI 520 between renewable energy power plant 510 and electrical grid 530, in some embodiments, a system can include multiple POIs, as described herein.

One or more embodiments described herein can operate without a grid connection. For example, the embodiments (i.e., system 300, system 400, and system 500) shown in FIGS. 3-5 can operate without a grid connection, by opening (or not even establishing) the electrical path to the POI. This may be desirable to a facility operator who, for regulatory or practical reasons, cannot access the electrical grid. Thus, one or more embodiments described herein can be built and operated without a grid connection while awaiting electrical grid access.

If such one or more embodiments are built and initially operated without a grid connection, a grid connection can nevertheless be added at a later date by supplying (adding, installing) the PCS B of that embodiment (and optionally the circuit breaker of that embodiment) between the common bus of that embodiment and the POI of that embodiment. This can be desirable to a facility operator who has been operating such one or more embodiments without grid access, while awaiting access to the electrical grid, and who now has electrical grid access. Upon obtaining electrical grid access, the additional power path can be managed by an extension of a control system. For example, a PCS B of a renewable energy power plant that is not connected to an electrical grid during a first time period and becomes connected to an electrical grid during a second time period after the first time period can, during the second time period, be configured to manage the additional power path.

FIG. 6 is a system block diagram of an inverter circuit 600, according to an embodiment. In some implementations, inverter circuit 600 can be used in the inverter 418 of FIG. 4. As shown in FIG. 6, the input voltage, Vdc, is a direct current input to the inverter circuit 600. Capacitor 610 can be a buffer capacitor that smooths out ripples associated with the input voltage Vdc. Switches 620 are arranged in a bridge. In some implementations, switches 620 can be under active control via a controller (e.g., controller 217 of FIG. 2, etc. ; not shown in FIG. 6), defining an active bridge. When the top right switch from switches 620 and the bottom left switch from switches 620 are closed, while the remaining two switches 620 are opened, the mid-section of the inverter circuit 600 has positive voltage on the upper rail and negative voltage on the lower rail; when the top left switch from switches 620 and the bottom right switch from switches 620 are closed and the other two switches are opened, the mid-section of the inverter circuit 600 has negative voltage on the upper rail and positive voltage on the lower rail. By cycling back and forth between these two switch configurations at the desired frequency, the mid-section of the inverter circuit 600 can be caused to have an alternating voltage applied to it, at the desired frequency. The inductor 632 and capacitor 634 in the middle of the circuit, along with the isolating output transformer 636, collectively create (define) a filter 630 to suppress harmonics of the desired frequency so that the output voltage, Vac, is close to a sinusoidal alternating current (AC) output.

In some alternative implementations, the filter 630 in the middle of the circuit can be more sophisticated, to achieve greater suppression of harmonics. Alternatively, or in addition, the isolating output transformer 636 can also be and/or include a step-up transformer, to achieve the desired output voltage.

The maximum power and/or electric current flow through the inverter circuit 600 can be determined by the input voltage Vdc, the duty cycle of the switches 620 and the rise time of the inductor 632 and capacitor 634 in the filter 630. In the embodiment of FIG. 6, limits for the switches 620, inductor 632, and/or capacitor 634 can be fixed (pre-defined, pre-selected) in advance, enabling the inverter circuit 600 to prevent excessive power and/or electric current flow to the POI (e.g., the POI 420 of FIG. 4). Similar to the discussion above in connection with FIG. 4, the inputs, outputs, and/or the operating parameters of the inverter circuit 600 can be controlled by internal controls (not shown) implemented in hardware (and in some instances firmware) without coordination with any other devices such as any other devices within a renewable energy power plant (e.g., renewable energy power plant 410 of FIG. 4). In other words, the inverter circuit 600 can operate based on control signals that exclusively control inverter circuit 600, can operate independent of any other device from a system (e.g., system 400 of FIG. 4). Said, another way, the inverter circuit 600 can be configured to limit the power flow therethrough without coordination with other devices such as other devices within the renewable energy power plant.

In some implementations, inverter circuit 600 can also be operated in the reverse direction, as a rectifier, so that AC power is applied on the right side (as shown in FIG. 6) and DC power is extracted on the left side (as shown in FIG. 6). To accomplish this, the switches 620 are activated in time with the input (ac) voltage so that when Vac applies a positive voltage to the top rail in the central part of the circuit (and a negative voltage to the bottom rail), the top right switch from switches 620 and the lower left switch from switches 620 are closed and the remaining two switches 620 are open; and when Vac applies a negative voltage to the top rail in the central part of the circuit (and a positive voltage to the bottom rail), the top left switch from switches 620 and the lower right switch from switches 620 are closed and the remaining two switches 620 are open. This switching sequence can ensure that the positive voltage will consistently be applied to the top rail on the left hand side of the bridge of switches 620, and the negative voltage will consistently be applied to the bottom rail, so that the voltage on the left side will consistently be of the same polarity (and, thus, would be DC). Additional filtering elements (not shown in FIG. 6) can be used on the DC output to smooth the output on that side.

For another example of managing a control system upon obtaining electrical grid access, returning to FIG. 5, AC/AC converter 518 directs output power to the POI 520 while limiting the maximum power that may be routed to the POI 520. AC/AC converter 518 can be implemented, for example, as a rectifier in series with an inverter. The rectifier can convert the input AC voltage to DC voltage, which is then re-converted to AC with the desired frequency and output voltage. In some instances, the rectifier can be an instance of inverter circuit 600 configured to operate as a rectifier, and the inverter can be an instance of inverter circuit 600 configured to operate as an inverter.

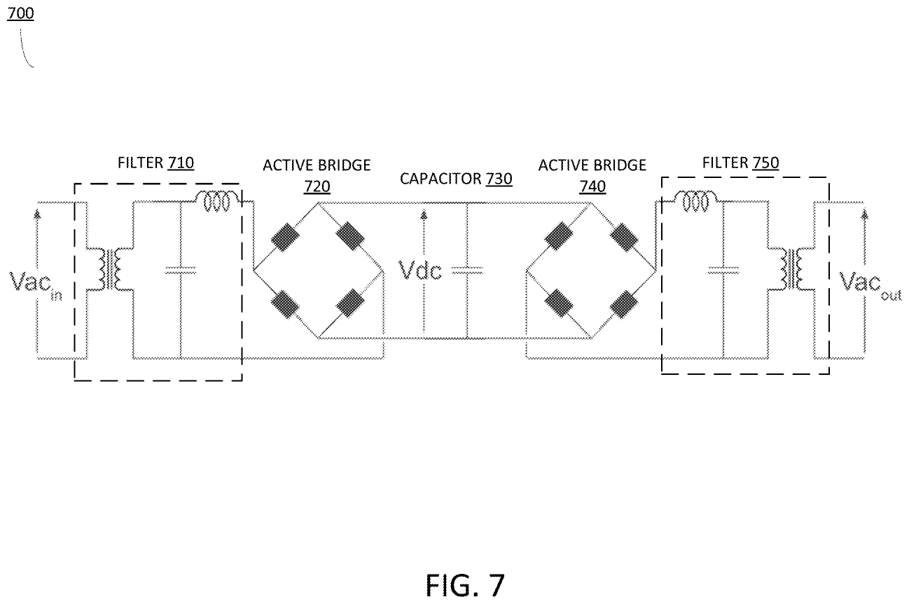

FIG. 7 shows a system block diagram of an AC/AC circuit 700, according to an embodiment. In some implementations, the AC/AC circuit 700 can be used in the AC/AC converter 518 of FIG. 5. Although not shown in FIG. 7, it should be understood that the AC/AC circuit 700 can include more filtration elements (components) as desired. Filtration elements in AC/AC circuit 700 include filter 710 (e.g., structurally and/or functionally similar to filter 630 of FIG. 6), capacitor 730 (e.g., structurally and/or functionally similar to capacitor 610 of FIG. 6), and filter 750 (e.g., structurally and/or functionally similar to filter 630 of FIG. 6).

As shown in FIG. 7, two active bridges (active bridge 720 and active bridge 740) are used (also referred to as a dual-active bridge design). The AC/AC circuit 700 can receive an AC input (labeled in FIG. 7 as “Vacᵢₙ”) on the left side of the AC/AC circuit 700 (from the perspective of FIG. 7). With power flowing from the left side to the right side of the AC/AC circuit 700 (from the perspective of FIG. 7), the left active bridge 720 acts as a rectifier, generating Vdc in the portion of the circuit between the two bridges. The right active bridge 740 acts as an inverter and its output, after filtration and passing through an isolating (and possibly voltage-multiplying) transformer (i.e., filter 750), delivers the desired AC output (labeled in FIG. 7 as “Vacₒᵤₜ”). Because the AC/AC circuit 700 shown in FIG. 7 is a dual-active bridge, the AC/AC circuit 700 can be operated in the reverse direction, taking power from the right side and delivering it to the left, with respect to the perspective of FIG. 7. In this case, the right-hand active bridge 740 acts as the rectifier and the left-side active bridge 720 acts as the inverter.

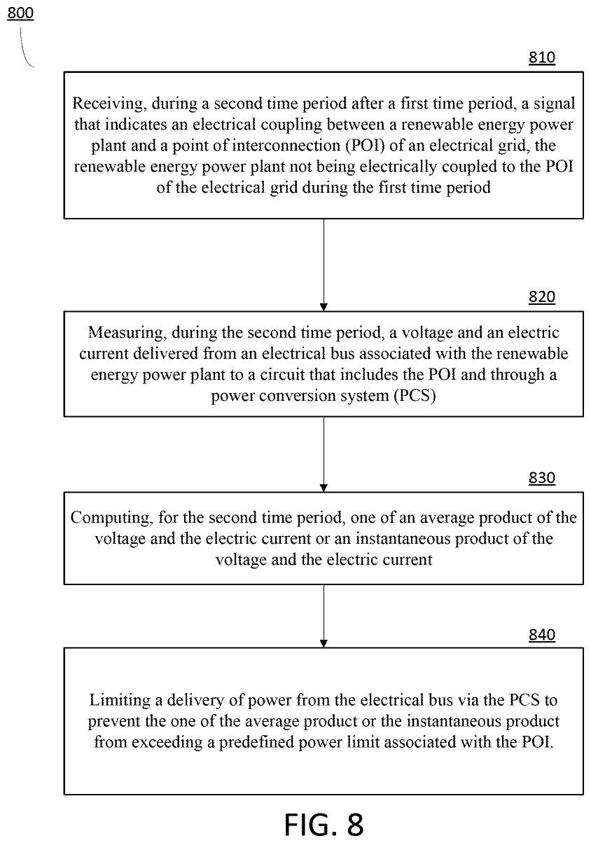

FIG. 8 shows a flow diagram of a method 800 for limiting power delivered to a POI of an electrical grid, according to an embodiment. In some implementations, the method 800 can be implemented by a power-limiting PCS (e.g., the power-limiting PCS 215 of FIG. 2, the PCS B 318 of FIG. 3, the inverter 418 of FIG. 4, the AC/AC converter 518 of FIG. 5, etc.). For example, the method 800 can be implemented using an electrical sensor, a controller, and an electronic switch such as those described in FIG. 2.

At 810, method 800 includes receiving, during a second time period after a first time period, a signal that indicates an electrical coupling between a renewable energy power plant and a point of interconnection (POI) of an electrical grid, the renewable energy power plant not being electrically coupled to the POI of the electrical grid during the first time period. In some implementations, during the first time period, the renewable energy power plant can have a power output that is not defined based on a power limit of the POI. For example, the renewable energy power plant can have a power output that exceeds the power limit of the POI.

At 820, method 800 includes measuring, during the second time period, a voltage and an electric current delivered from an electrical bus associated with the renewable energy power plant to a circuit that includes the POI of the electrical grid and through a power conversion system (PCS). The electrical bus can be, for example, the electrical bus of any of the embodiments of FIGS. 2-5. The POI of the electrical grid can be, for example, a POI of an electrical grid described in connection with the embodiments of FIGS. 2-5. The PCS can be, for example, the PCS of any of the embodiments of FIGS. 2-7.

At 830, method 800 includes computing, for the second time period, one of an average product of the voltage and the electric current or an instantaneous product of the voltage and the electric current. For example, in some implementations, method 800 can include computing, for one or more times within the time period, one or more instantaneous products of the voltage and the electric current.

At 840, method 800 includes, limiting a delivery of power from the electrical bus via the PCS to prevent the one of the average product or the instantaneous product from exceeding a predefined power limit associated with the POI. For example, the one of the average product or the instantaneous product can be, as a percentage of the predefined power limit, 99.9%, 99%, 95%, 92%, 90%, 85%, 80%, 75%, and/or the like. In some implementations, the predefined power limit can be the physical (i.e., defined by physics) power limit of the POI, for example, established by a system operator of the electrical grid. In some implementations, the predefined power limit can be less than the physical power limit of the POI, for example, a power limit selected from a range of values by a system operator of the renewable energy power plant, by the PCS controller, etc.

In some implementations, method 800 can additionally or alternatively to 840 include limiting a delivery of current from the electrical bus via the PCS to prevent the electric current from exceeding a predefined current limit associated with the POI. In some implementations, the predefined current limit can be the physical (i.e., defined by physics) current limit of the POI, for example, established by a system operator of the electrical grid. In some implementations, the predefined current limit can be less than the physical current limit of the POI, for example, a current limit selected from a range of values by a system operator of the renewable energy power plant, by the PCS controller, etc.

In some implementations, method 800 can further include causing a BESS to send, to the electrical bus, additional power. For example, when a power demand of the electrical grid (and/or a power limit/current limit of the POI) exceeds an available power on a common bus, the BESS can discharge to send additional power to the common bus, which can be sent to the POI via the PCS.

In some embodiments, a system comprises: a renewable energy power plant having a power conversion system (PCS) that has fixed characteristics to limit at least one of an amount of power or an amount of current flow, the PCS configured to be electrically coupled to a point of interconnection (POI) of an electrical grid, the renewable energy power plant configured to be coupled to at least one of a battery energy storage system (BESS) or a behind-the-meter (BTM) load, the renewable energy power plant configured to (1) send, to the at least one of the BESS or the BTM load, power greater than a power limit of the POI and (2) not send power to the POI that exceeds the power limit of the POI.

In some such implementations, the renewable energy power plant is in a first configuration in a first time period that is associated with a lack of access to the electrical grid, the renewable energy power plant is in a second configuration in a second time period that is associated with access to the electrical grid and that is after the first time period, the PCS, when the renewable energy power plant in the first configuration, is not connected to the electrical grid.

In some such implementations, the PCS is of a first type; and the renewable energy power plant includes a plurality of renewable energy sources and at least one PCS of a second type different from the first type.

In some such implementations, the PCS is an inverter; the renewable energy power plant includes a plurality of renewable energy sources and a plurality of direct current (DC)/DC converters that are electrically connected to define a common DC bus.

In some such implementations, the PCS is an alternating current (AC)/AC converter; the renewable energy power plant includes a plurality of renewable energy sources and a plurality of inverters that are electrically connected to define a common AC bus.

In some such implementations, the renewable energy power plant is configured to send, to the at least one of the BESS or the BTM load, power three times greater than a power limit of the POI.

In some such implementations, the renewable energy power plant is configured to send, to the at least one of the BESS or the BTM load, power five times greater than a power limit of the POI.

In some such implementations, the renewable energy power plant is configured to send, to the at least one of the BESS or the BTM load, power eight times greater than a power limit of the POI.

In some embodiments, a system comprises: a renewable energy power plant including (a) an electrical bus configured to be electrically coupled to at least one of a first circuit that includes a battery energy storage system (BESS) or a second circuit that includes a behind-the-meter (BTM) load and (b) a power conversion system (PCS), a first portion of the PCS configured to be electrically coupled to the electrical bus, a second portion of the PCS configured to be electrically coupled to a third circuit that includes a point of interconnection (POI) of an electrical grid, the PCS configured to limit at least one of an amount of power or an amount of current flow between the electrical bus and the third circuit, the renewable energy power plant configured to have a power output higher than a power limit of the POI.

In some such implementations, the renewable energy power plant is in a first configuration during a first time period that is associated with a lack of access to the electrical grid, and the renewable energy power plant is in a second configuration during a second time period that is associated with access to the electrical grid and that is after the first time period.

In some such implementations, the PCS is of a first type; and the renewable energy power plant includes a plurality of renewable energy sources and at least one PCS of a second type different from the first type.

In some such implementations, the PCS is an inverter; the renewable energy power plant includes a plurality of renewable energy sources and a plurality of direct current (DC)/DC converters that are electrically connected to define a common DC bus, the electrical bus being the common DC bus.

In some such implementations, the PCS is an alternating current (AC)/AC converter; the renewable energy power plant includes a plurality of renewable energy sources and a plurality of inverters that are electrically connected to define a common AC bus, the electrical bus being the common AC bus.

In some such implementations, the PCS is an alternating current (AC)/AC converter; the renewable energy power plant includes a plurality of renewable energy sources and at least one grid-forming inverter configured to set at least one of an electrical frequency or an AC voltage of the electrical bus.

In some such implementations, the renewable energy power plant is in a first configuration during a first time period that is associated with a lack of access to the electrical grid, the renewable energy power plant is in a second configuration during a second time period that is associated with access to the electrical grid and that is after the first time period, the renewable energy power plant in the first configuration lacks the PCS, and the renewable energy power plant in the second configuration includes the PCS.

In some embodiments, a system comprises: a renewable energy power plant having a power conversion system (PCS) configured to be electrically coupled to a point of interconnection (POI) of an electrical grid, the renewable energy power plant configured to be coupled to at least one of a battery energy storage system (BESS) or a behind-the-meter (BTM) load, the renewable energy power plant configured to send, to the at least one of the BESS or the BTM load, power greater than a power limit of the POI, the PCS configured to restrict, without communicating with remaining portions of the system, power to the POI that exceeds the power limit of the POI.

In some such implementations, the PCS is configured to restrict, without communicating with a power meter that monitors a power flow within a remaining portion of the renewable energy power plant, power to the POI.

In some such implementations, the renewable energy power plant further includes a circuit breaker configured to electrically disconnect the PCS from the POI.

In some such implementations, the renewable energy power plant is configured to send, to the at least one of the BESS or the BTM load, power that is at least approximately three times greater than the power limit of the POI.

In some such implementations, the renewable energy power plant is configured to send, to the at least one of the BESS or the BTM load, power that is at least approximately five times greater than the power limit of the POI.

In some embodiments, a method comprises: receiving, during a second time period after a first time period, a signal that indicates an electrical coupling between a renewable energy power plant and a point of interconnection (POI) of an electrical grid, the renewable energy power plant not being electrically coupled to the POI of the electrical grid during the first time period; measuring, during the second time period, a voltage and an electric current delivered from an electrical bus associated with the renewable energy power plant to a circuit that includes the POI and through a power conversion system (PCS); computing, for the second time period, an average product of the voltage and the electric current; and limiting a delivery of power from the electrical bus via the PCS to prevent the one of the average product or the instantaneous product from exceeding a predefined power limit associated with the POI.

Combinations of the foregoing concepts and additional concepts discussed here (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The drawings primarily are for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

The entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments may not have been presented for a specific portion of the innovations or that further undescribed alternate embodiments may be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure.

It is to be understood that the logical and/or topological structure of any combination of any program components (a component collection), other components and/or any present feature sets as described in the Figures and/or throughout are not limited to a fixed operating order and/or arrangement, but rather, any disclosed order is an example and all equivalents, regardless of order, are contemplated by the disclosure.

The phrase “based on” does not mean “based only on,” unless expressly specified otherwise. In other words, the phrase “based on” describes both “based only on” and “based at least on.”

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used in this specification and the appended claims, the singular forms “a,” “an” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and/or “approximately” when used in conjunction with numerical values and/or ranges generally refer to those numerical values and/or ranges near to a recited numerical value and/or range. For example, in some instances, “about 40 [units]” can mean within ±25% of 40 (e.g., from 30 to 50). In some instances, the terms “about” and “approximately” can mean within ±10% of the recited value. In other instances, the terms “about” and “approximately” can mean within ±9%, ±8%, ±7%, ±6%, ±5%, ±4%, ±3%, ±2%, ±1%, less than ±1%, or any other value or range of values therein or therebelow. The terms “about” and “approximately” may be used interchangeably. Furthermore, although a numerical value modified by the term “about” or “approximately” can allow for and/or otherwise encompass a tolerance of the stated numerical value, it is not intended to exclude the exact numerical value stated.

In a similar manner, term “substantially” when used in connection with, for example, a geometric relationship, a numerical value, and/or a range is intended to convey that the geometric relationship (or the structures described thereby), the number, and/or the range so defined is nominally the recited geometric relationship, number, and/or range. For example, two structures described herein as being “substantially non-parallel” is intended to convey that, although a non-parallel geometric relationship is desirable, some parallelism can occur in a “substantially non-parallel” arrangement. Such tolerances can result from manufacturing tolerances, measurement tolerances, and/or other practical considerations (such as, for example, minute imperfections, age of a structure so defined, a pressure or a force exerted within a system, and/or the like). As described above, a suitable tolerance can be, for example, of ±1%, ±2%, ±3%, +4%, ±5%, ±6%, ±7%, ±8%, ±9%, +10%, or more of the stated geometric construction, numerical value, and/or range. Furthermore, although a numerical value modified by the term “substantially” can allow for and/or otherwise encompass a tolerance of the stated numerical value, it is not intended to exclude the exact numerical value stated.

The specific configurations of the various components described herein can also be varied. For example, the size and specific shape of the various components can be different from the embodiments shown, while still providing the functions as described herein. Additionally, the relative size of various components of the devices shown and described herein with respect to the size of other components of the devices are not necessarily to scale.

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features may not necessarily be limited to a particular order of execution, but rather, any number of processes, services, and/or the like may be performed or occur serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others. Similarly, where methods and/or events described above indicate certain events and/or procedures occurring in certain order, the ordering of certain events and/or procedures may be modified. While the embodiments have been particularly shown and described, it will be understood that various changes in form and details may be made.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor, and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

While specific embodiments of the present disclosure have been outlined above, many alternatives, modifications, and variations will be apparent to those skilled in the art. Accordingly, the embodiments set forth herein are intended to be illustrative, not limiting.

What is claimed is:

1. A system, comprising:
a renewable energy power plant having a power conversion system (PCS) that has fixed characteristics to limit at least one of an amount of power or an amount of current flow, the PCS configured to be electrically coupled to a point of interconnection (POI) of an electrical grid,
the renewable energy power plant configured to be coupled to at least one of a battery energy storage system (BESS) or a behind-the-meter (BTM) load,
the renewable energy power plant configured to (1) send, to the at least one of the BESS or the BTM load, power greater than a power limit of the POI and (2) not send power to the POI that exceeds the power limit of the POI.

2. The system of claim 1, wherein:
the renewable energy power plant is configured to be in a first configuration in a first time period that is associated with a lack of access to the electrical grid,
the renewable energy power plant is configured to be in a second configuration in a second time period that is associated with access to the electrical grid and that is after the first time period, and
the PCS, when the renewable energy power plant in the first configuration, is not connected to the electrical grid.

3. The system of claim 1, wherein:
the PCS is of a first type; and
the renewable energy power plant includes a plurality of renewable energy sources and at least one PCS of a second type different from the first type.

4. The system of claim 1, wherein:
the PCS is an inverter;
the renewable energy power plant includes a plurality of renewable energy sources and a plurality of direct current (DC)/DC converters that are electrically connected to define a common DC bus.

5. The system of claim 1, wherein:
the PCS is an alternating current (AC)/AC converter;
the renewable energy power plant includes a plurality of renewable energy sources and a plurality of inverters that are electrically connected to define a common AC bus.

6. The system of claim 1, wherein the renewable energy power plant is configured to send, to the at least one of the BESS or the BTM load, power three times greater than a power limit of the POI.

7. The system of claim 1, wherein the renewable energy power plant is configured to send, to the at least one of the BESS or the BTM load, power five times greater than a power limit of the POI.

8. The system of claim 1, wherein the renewable energy power plant is configured to send, to the at least one of the BESS or the BTM load, power eight times greater than a power limit of the POI.

9. A system, comprising:
a renewable energy power plant including (a) an electrical bus configured to be electrically coupled to at least one of a first circuit that includes a battery energy storage system (BESS) or a second circuit that includes a behind-the-meter (BTM) load and (b) a power conversion system (PCS), a first portion of the PCS configured to be electrically coupled to the electrical bus, a second portion of the PCS configured to be electrically coupled to a third circuit that includes a point of interconnection (POI) of an electrical grid,
the PCS configured to limit at least one of an amount of power or an amount of current flow between the electrical bus and the third circuit,
the renewable energy power plant configured to have a power output higher than a power limit of the POI.

10. The system of claim 9, wherein:
the renewable energy power plant is in a first configuration during a first time period that is associated with a lack of access to the electrical grid, and
the renewable energy power plant is in a second configuration during a second time period that is associated with access to the electrical grid and that is after the first time period.

11. The system of claim 9, wherein:
the PCS is of a first type; and
the renewable energy power plant includes a plurality of renewable energy sources and at least one PCS of a second type different from the first type.

12. The system of claim 9, wherein:
the PCS is an inverter;
the renewable energy power plant includes a plurality of renewable energy sources and a plurality of direct current (DC)/DC converters that are electrically connected to define a common DC bus,
the electrical bus being the common DC bus.

13. The system of claim 9, wherein:
the PCS is an alternating current (AC)/AC converter;
the renewable energy power plant includes a plurality of renewable energy sources and a plurality of inverters that are electrically connected to define a common AC bus,
the electrical bus being the common AC bus.

14. The system of claim 9, wherein:
the PCS is an alternating current (AC)/AC converter;
the renewable energy power plant includes a plurality of renewable energy sources and at least one grid-forming inverter configured to set at least one of an electrical frequency or an AC voltage of the electrical bus.

15. The system of claim 9, wherein:
the renewable energy power plant is configurable between (1) a first configuration that does not include access to the electrical grid and in which the renewable energy power plant does not include the PCS, and (2)
the renewable energy power plant is in a second configuration that includes access to the electrical grid and in which the renewable energy power plant includes the PCS.

16. A system, comprising:
a renewable energy power plant having a power conversion system (PCS) configured to be electrically coupled to a point of interconnection (POI) of an electrical grid,
the renewable energy power plant configured to be coupled to at least one of a battery energy storage system (BESS) or a behind-the-meter (BTM) load,
the renewable energy power plant configured to send, to the at least one of the BESS or the BTM load, power greater than a power limit of the POI,
the PCS configured to restrict, without communicating with remaining portions of the system, power to the POI that exceeds the power limit of the POI.

17. The system of claim 16, wherein the PCS is configured to restrict, without communicating with a power meter that monitors a power flow within a remaining portion of the renewable energy power plant, power to the POI.

18. The system of claim 16, wherein the renewable energy power plant further includes a circuit breaker configured to electrically disconnect the PCS from the POI.

19. The system of claim 16, wherein the renewable energy power plant is configured to send, to the at least one of the BESS or the BTM load, power that is at least approximately three times greater than the power limit of the POI.

20. The system of claim 16, wherein the renewable energy power plant is configured to send, to the at least one of the BESS or the BTM load, power that is at least approximately five times greater than the power limit of the POI.

21. A method, comprising:
receiving, during a second time period after a first time period, a signal that indicates an electrical coupling between a renewable energy power plant and a point of interconnection (POI) of an electrical grid, the renewable energy power plant not being electrically coupled to the POI of the electrical grid during the first time period;
measuring, during the second time period, a voltage and an electric current delivered from an electrical bus associated with the renewable energy power plant to a circuit that includes the POI and through a power conversion system (PCS);
computing, for the second time period, one of an average product of the voltage and the electric current or an instantaneous product of the voltage and the electric current; and
limiting a delivery of power from the electrical bus via the PCS to prevent the one of the average product or the instantaneous product from exceeding a predefined power limit associated with the POI.
